(19) United States
(12) Patent Application Publication
(10) Pub. No.: US 2003/0110205 A1
(43) Pub. Date: Jun. 12, 2003

(54) Virtualized resources in a partitionable server

(76) Inventor: Leith Johnson, Fort Collins, CO (US)

Correspondence Address: HEWLETT-PACKARD COMPANY, Intellectual Property Administration, P.O. Box 272400, Fort Collins, CO, 80527-2400, US

(21) Appl. No.: 10/017,371

(22) Filed: Dec. 7, 2001

(51) Int. Cl. G06F 9/00

(52) U.S. Cl. 709/104; 709/1

(57) ABSTRACT

An address translation mechanism is provided for use in a partitionable server. In one embodiment, the address translation mechanism provides a sequential zero-based physical memory address space to each of the server's partitions. The translation mechanism maintains mappings between the partitions' physical memory address spaces and a machine memory address space that maps to the real (hardware) memory of the server. The translation mechanism transparently translates physical addresses referenced in memory access requests into machine addresses. As a result, conventional operating systems and other processes that are designed to access sequential zero-based addressed spaces may execute in partitions of a partitionable server without modification. Techniques are also provided for remapping a range of physical memory addresses from one machine (hardware) memory resource to another in a partitionable server, thereby enabling machine memory to be replaced without requiring the server to be rebooted.

### BACKGROUND

1. Field of the Invention

The present invention relates to resource management in a computer system and, more particularly, to the virtualization of resources in a partitionable server.

2. Related Art

Computer system owners and operators are continually seeking to improve computer operating efficiencies and hence to reduce the cost of providing computing services. For example, servers of various kinds—such as database servers, web servers, email servers, and file servers—have proliferated within enterprises in recent years. A single enterprise may own or otherwise employ the services of large numbers of each of these kinds of servers. The cost of purchasing (or leasing) and maintaining such servers can be substantial. It would be advantageous, therefore, to reduce the number of servers that must be used by an enterprise without decreasing system performance.

One way to reduce the number of servers is through the process of “server consolidation,” in which multiple independent servers are replaced by a single server, referred to herein as a “consolidation server.” A consolidation server is typically a powerful computer system having significant computing resources (such as multiple processors and large amounts of memory). The consolidation server may be logically subdivided into multiple “partitions,” each of which is allocated a portion of the server's resources. Each partition may execute its own operating system and software applications, and otherwise act similarly to an independent physical computer.

Unlike a collection of independent servers, it is possible to dynamically adjust the resources available to each partition/application. Many applications experience variation in workload demand, which is frequently dependent on time of day, day of month, etc. Periods of high workload demand are frequently not coincident. Applying available resources to current high-demand workloads achieves improved resource utilization, decreased overall resource requirements, and therefore reduced overall cost.

Various approaches have been developed for allocating resources among partitions in a partitionable server. The following description will focus specifically on the allocation of memory for purposes of example. To this end, a brief overview will first be provided of the operation of memory subsystems in conventional computers.

Referring to FIG. 1, a memory model 100 representative of the kind typically associated with a conventional computer (not shown) is illustrated in block diagram form. The memory model 100 includes two kinds of address spaces: a physical (or “real”) address space 102 and a plurality of virtual address spaces 108a-c. In general, the term “address space” refers to a set of memory addresses (or other resource identifiers) that may be used by a computer to access memory locations (or other resources).

The physical address space 102 will be described first. A computer typically includes multiple physical (hardware) memory blocks 110a-d, which may be of varying size. Each of the blocks (which may, for example, correspond to a physical memory unit such as a DIMM) includes a plurality of memory locations that may be accessed by the CPU of the computer using one or more memory controllers (not shown).

The physical memory blocks 110a-d are illustrated in FIG. 1 in a contiguous linear arrangement to indicate that there is a one-to-one mapping between memory locations in the physical memory blocks 110a-d and a range of physical addresses 112 that are numbered sequentially beginning with zero and ending with M−1, where M is the aggregate number of memory locations in the physical memory blocks 110a-d. For example, if physical memory block 110a has 16 memory locations, the addresses (in the address range 112) corresponding to these memory locations are typically numbered sequentially from zero to 15. The addresses corresponding to the memory locations in physical memory block 110b are typically numbered sequentially beginning at address 16 (i.e., immediately after the last address in physical memory block 110a), and so on. As a result, there is a one-to-one mapping between the memory locations in the physical memory blocks 110a-d and the range of addresses 112, which is numbered sequentially beginning with zero. In general, an address space that is numbered sequentially beginning with zero will be referred to herein as a “sequential zero-based address space.” This mapping of physical memory locations to addresses 112 in the physical address space 102 is typically maintained by one or more memory controllers (not shown).

The memory model 100 also includes a translation mechanism 104, shown generally in block diagram form in FIG. 1. The translation mechanism 104 is typically implemented using one or more processors, portions of an operating system executing on the computer, and other hardware and/or software as is well known to those of ordinary skill in the art.

The translation mechanism 104 logically subdivides addresses 112 in the physical address space 102 into distinct and contiguous logical units referred to as pages, each of which typically contains 4 Kbytes of memory. Sixteen pages, numbered sequentially beginning with page zero, are depicted in FIG. 1 for purposes of example. For example, the physical addresses of memory locations in Page 0 range from 0 to 4095, in Page 1 from 4096 to 8191, and so on.

Application programs and other software processes executing on the computer do not access memory directly using the addresses 112 in the physical address space 102. Rather, a layer of indirection is introduced by the translation mechanism 104. The translation mechanism 104 typically allocates a “virtual address space” to each process executing on the computer. Three virtual address spaces 108a-c, each of which corresponds to a particular process executing on the computer, are shown in FIG. 3 for purposes of example.

More specifically, when a process is created, it typically requests that it be provided with a certain amount of memory. In response to such a request, the translation mechanism 104 creates a virtual address space for the process by allocating one or more (possibly non-consecutive) pages from the physical address space 102 to the process. For example, as shown in FIG. 1, virtual address space 108a has been allocated pages 9, 3, 2, and 12. The translation mechanism 104 establishes a one-to-one mapping between memory locations in the virtual address space 108a and a contiguous range of virtual addresses 114a numbered sequentially from zero to N₀−1, where N₀ is the amount of memory allocated to virtual address space 108a. The translation mechanism 104 maintains a virtual-to-physical address translation table that maps the virtual addresses 114a in the virtual address space 108a to corresponding physical addresses 112 in the physical address space 102. Similarly, virtual address space 108b has a range of virtual addresses 114b and virtual address space 108c has a range of virtual addresses 114c.

From the point of view of the process to which virtual address space 108a has been allocated, the virtual address space 108a appears to be a single contiguous block of memory (sometimes referred to as “virtual memory”). When the process attempts to read from or write to a memory location in the virtual address space 108a, the translation mechanism 104 receives the request and transparently accesses the appropriate physical memory location in the physical address space 102 on behalf of the process. Use of the translation mechanism 104 allows each process that executes on the computer to be designed to work in conjunction with a sequential zero-based address space, regardless of the addresses of the actual physical memory locations that are allocated to the process. This greatly simplifies and standardizes the design and execution of processes on the computer, as well as providing other benefits.

Memory models such as the memory model 100 shown in FIG. 1 are typically designed to work with standalone computers executing a single operating system. Conventional operating systems, for example, which are typically responsible for providing at least part of the functionality of the translation mechanism 104, are typically designed to assume that the physical address space 102 is a sequential zero-based address space. This assumption is typically valid for independent computers executing a single operating system. As described above, however, in certain circumstances it is desirable to partition a computer into a plurality of logical partitions, one or more of which may be allocated an address space that is not zero-based and/or is not physically contiguous. Conventional operating systems may fail to execute within such partitions unless special provisions for their proper operation are made.

Some attempts have been made to address this problem. Most existing partitioning schemes, for example, employ some kind of “soft” or “virtual” partitioning. In a virtual partitioned system, a master operating system (sometimes referred to as a “hypervisor”) hosts multiple slave operating systems on the same physical computer. Typically, such a master operating system employs a single translation mechanism, similar to the translation mechanism 104 shown in FIG. 1. The master operating system controls the translation mechanism on behalf of the slave operating systems. This approach has a number of drawbacks. For example, there is typically a performance penalty (commonly on the order of 10-15%) due to the extra overhead represented by the translation mechanism. Additionally, the master operating system represents a single point of failure for the entire system; if the master operating system fails, all of the slave operating systems will also fail as a result.

Furthermore, in such a system the computer's hardware itself represents a single point of failure. More particularly, a failure in any processor or memory controller in the computer will likely cause the master operating system to fail, thereby causing all of the slave operating systems to fail as well. Finally, such a system requires that the slave operating systems be specially designed to work in conjunction with the master operating system. As a result, conventional operating systems, which typically are not designed to operate as slaves to a master operating system, will either not function in such a system or require modification to function properly. It may be difficult or impossible to perform such modifications, and the deep penetration of conventional operating systems (such as Microsoft Windows NT and various forms of Unix) may limit the commercial acceptance of servers on which conventional operating systems cannot execute.

Another approach is to provide partitions in which the address space presented to each operating system is not guaranteed to be zero-based and in which addresses are not guaranteed to increase sequentially. This approach, however, has a number of drawbacks. For example, it requires the use of a modified operating system, because conventional operating systems expect the physical address space to begin at zero and to increase sequentially. Furthermore, providing an address space that does not increase sequentially (i.e., that is not contiguous) requires another layer to be provided in the translation mechanism 104, usually in the operating system page tables. The introduction of such an additional layer typically reduces the performance of the translation mechanism 104.

What is needed, therefore, is a mechanism for providing sequential zero-based physical address spaces for each partition of a partitionable server.

Another goal of a partitionable server is to allow physical memory blocks to be replaced in a partition of the server without requiring that the operating system be rebooted. One reason that performing such addition or removal of physical memory blocks can be difficult to perform without rebooting is that certain pages of memory may become “pinned.” I/O adapters typically communicate with the operating system via buffers addressed in the physical address space 102. Typically it is not possible to update the physical addresses of these buffers without rebooting the system.

What is needed, therefore, is a reliable mechanism for replacing machine memory blocks in a partitionable server without requiring that the computer be rebooted.

### SUMMARY

In one aspect, a method is provided for creating a physical resource identifier space in a partition of a partitionable computer system that includes a plurality of machine resources having a plurality of machine resource identifiers. The method includes steps of: (A) establishing a mapping between a plurality of physical resource identifiers and at least some of the plurality of machine resource identifiers, wherein the plurality of physical resource identifiers are numbered sequentially beginning with zero; and (B) providing, to a software program (such as an operating system) executing in the partition, an interface for accessing the at least some of the plurality of machine resources using the plurality of physical resource identifiers. In one embodiment, the plurality of machine resources comprises a plurality of machine memory locations, the plurality of machine resource identifiers comprises a plurality of machine memory addresses, the machine resource identifier space comprises a machine memory address space, and the plurality of physical resource identifiers comprises a plurality of physical memory addresses. The steps (A) and (B) may be performed for each of a plurality of partitions of the partitionable computer.

The step (A) may include a step of creating an address translation table that records the mapping between the plurality of physical resource identifiers and the at least some of the plurality of machine resource identifiers. The interface may include means (such as a content Addressable Memory) for translating a physical resource identifier selected from among the plurality of physical resource identifiers into one of the plurality of machine resource identifiers in accordance with the mapping.

In another aspect, a method is provided for use in a partitionable computer system that includes a plurality of machine resources having a plurality of machine resource identifiers. The method accesses a select one of the plurality of machine resources specified by a physical resource identifier by performing steps of: (A) identifying a mapping associated with a partition in the partitionable server, wherein the mapping maps a plurality of physical resource identifiers in a sequential zero-based physical resource identifier space of the partition to at least some of the plurality of machine resource identifiers; (B) translating the physical resource identifier into a machine resource identifier using the mapping, wherein the machine resource identifier specifies the select one of the plurality of machine resources; and (C) causing the select one of the plurality of machine resources to be accessed using the machine resource identifier. In one embodiment, the plurality of machine resources is a plurality of machine memory locations, the plurality of machine resource identifiers is a plurality of machine memory addresses, the machine resource identifier space is a machine memory address space, and the plurality of physical resource identifiers is a plurality of physical memory addresses. The step (C) may include a step of reading a datum from or writing a datum to the machine memory address.

In another aspect, a method is provided for use in a partitionable computer system including a plurality of machine memory locations having a plurality of machine memory addresses, a plurality of physical memory locations having a plurality of physical memory addresses that are mapped to at least some of the plurality of machine memory addresses, and a plurality of partitions executing a plurality of software programs. The method includes steps of: (A) selecting a first subset of the plurality of physical memory locations, the first subset of the plurality of memory locations being mapped to a first subset of the plurality of machine memory addresses; and (B) remapping the first subset of the plurality of memory locations to a second subset of the plurality of machine memory addresses without rebooting the partitionable computer system. Prior to performing the step (B), the contents of the first subset of the plurality of machine memory addresses may be copied to the second subset of the plurality of machine memory addresses.

Other features and advantages of various aspects and embodiments of the present invention will become apparent from the following description and from the claims.

### BRIEF DESCRIPTION OF THE DRAWINGS

FIG. 1 is a functional block diagram of a memory model used by conventional computers.

FIG. 2 is a functional block diagram of a memory model suitable for use in a partitionable server according to one embodiment of the present invention.

FIG. 3A is a functional block diagram of resources in a partitionable server.

FIG. 3B is a functional block diagram of a partitionable server having two partitions.

FIG. 4 is a flow chart of a method performed by a physical-to-machine translation mechanism to create a physical memory space according to one embodiment of the present invention.

FIG. 5 is a flow chart of a method performed by a physical-to-machine translation mechanism to translate a physical memory address into a machine memory address according to one embodiment of the present invention.

FIG. 6 is a functional block diagram of a generalized physical resource model suitable for use in a partitionable server according to one embodiment of the present invention.

FIG. 7 is a flowchart of a method that is used to remap a physical memory block from one physical memory resource to another in one embodiment of the present invention.

FIG. 8 is a schematic diagram of a hardware implementation of a physical-to-machine translation mechanism according to one embodiment of the present invention.

### DETAILED DESCRIPTION

In one aspect of the present invention, a translation mechanism is provided for use in a partitionable server. The translation mechanism is logically interposed between the server's hardware memory resources and processes (such as operating systems and user processes) executing in partitions of the server. For each partition, the translation mechanism allocates a portion of the server's memory resources to a “physical” address space that may be accessed by processes executing within the partition. Each such physical address space is sequential and zero-based. As described in more detail below, the “physical” address spaces used in various embodiments of the present invention may actually be virtual address spaces, but are referred to as “physical” address spaces to indicate that they may be accessed by processes (such as operating systems) in the same manner as such processes may access physical (hardware) addresses spaces in a conventional standalone computer.

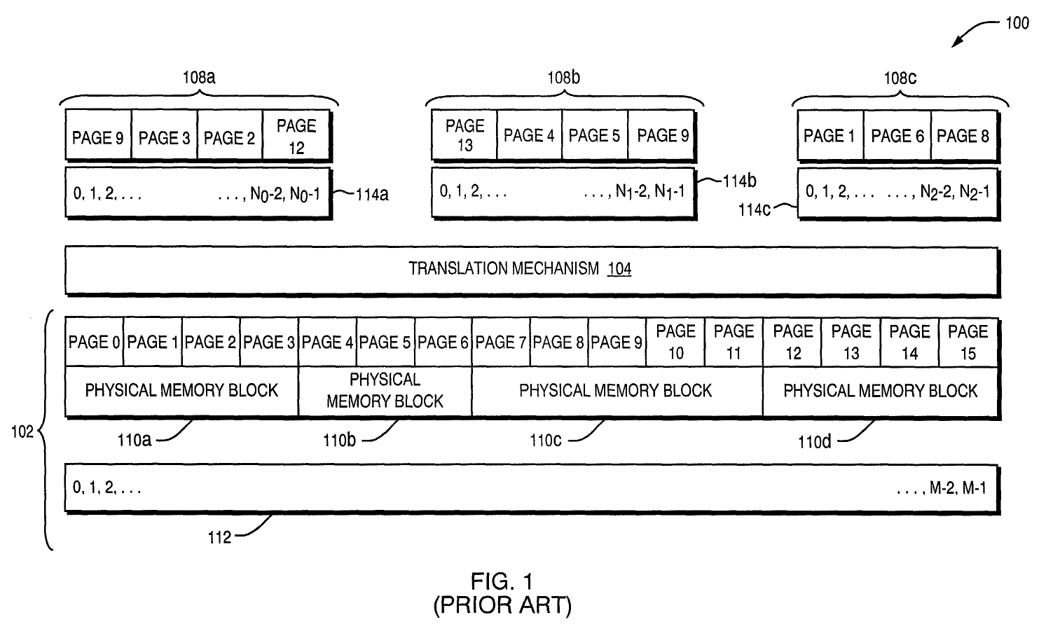

The translation mechanism maintains mappings between the partitions' physical address spaces and a “machine” address space that maps to the real (hardware) memory of the server. The “machine” address space is in this way similar to the “physical” address space of a conventional non-partitioned computer, described above with respect to FIG. 1. When a process (such as an operating system) executing in a partition issues a conventional request to read from or write to a specified physical memory address, the translation mechanism receives the request, transparently translates the specified physical memory address into a machine memory address, and instructs memory control hardware in the server to perform the requested read or write operation on behalf of the requesting process.

Operation of the translation mechanism is transparent to operating systems and other processes executing in partitions of the server. In particular, such processes may access memory in partitions of the server using the same commands that may be used to access the memory of a non-partitionable computer. The translation mechanism thereby enables existing conventional operating systems to execute within partitions of the partitionable server without modification.

In another aspect of the present invention, techniques are provided for remapping a range of physical memory addresses from one machine (hardware) memory resource to another in a partitionable server. In particular, techniques are provided for performing such remapping without requiring the server to be rebooted and without interrupting operation of the operating system(s) executing on the server. The ability to perform such remapping may be used, for example, to enable machine memory to be replaced without requiring the server to be rebooted.

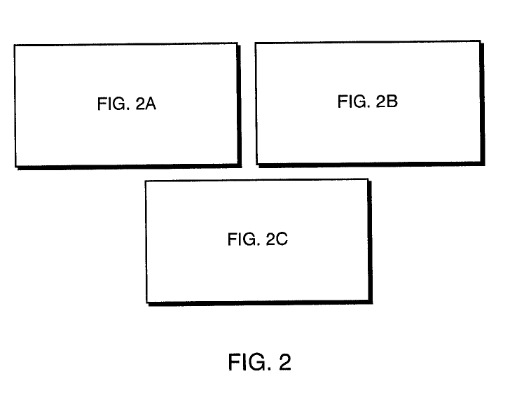

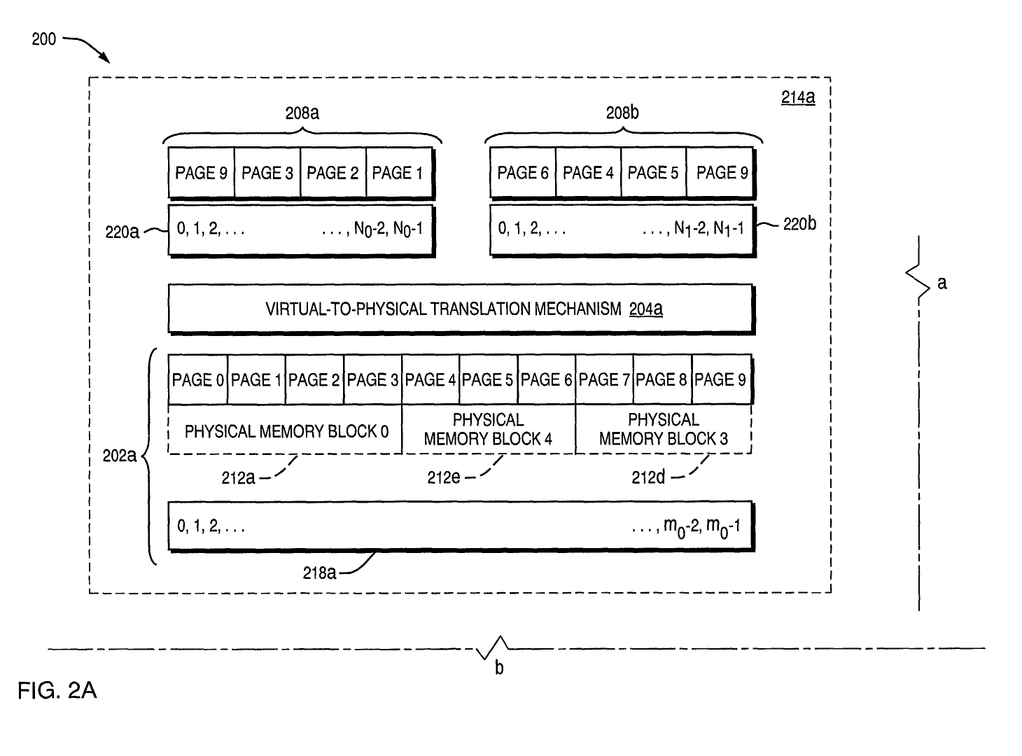

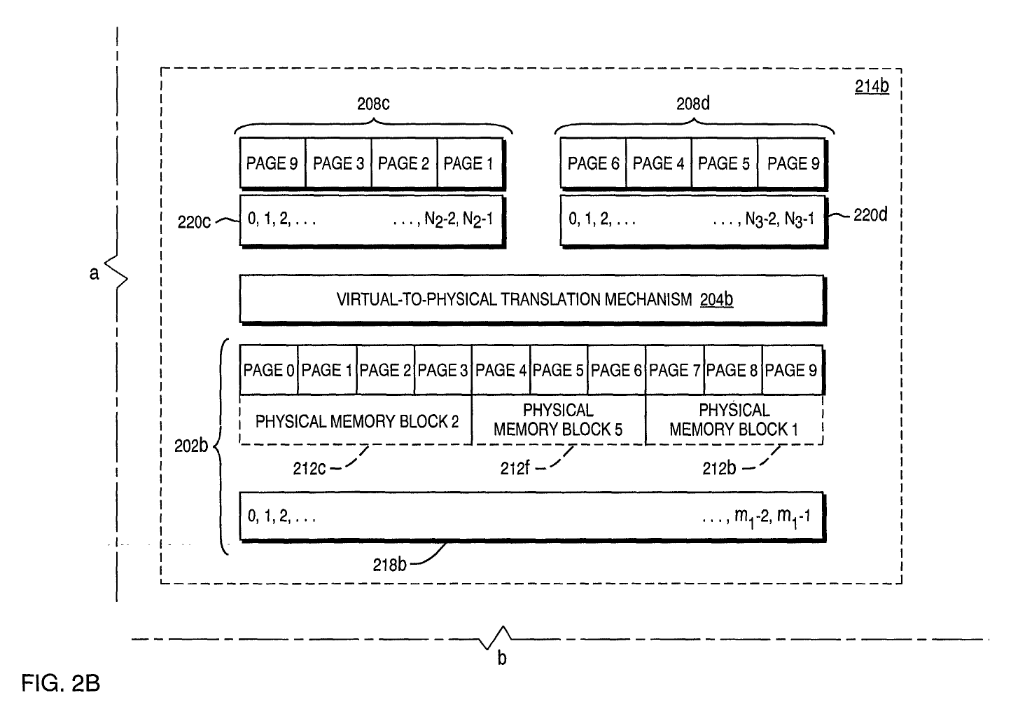

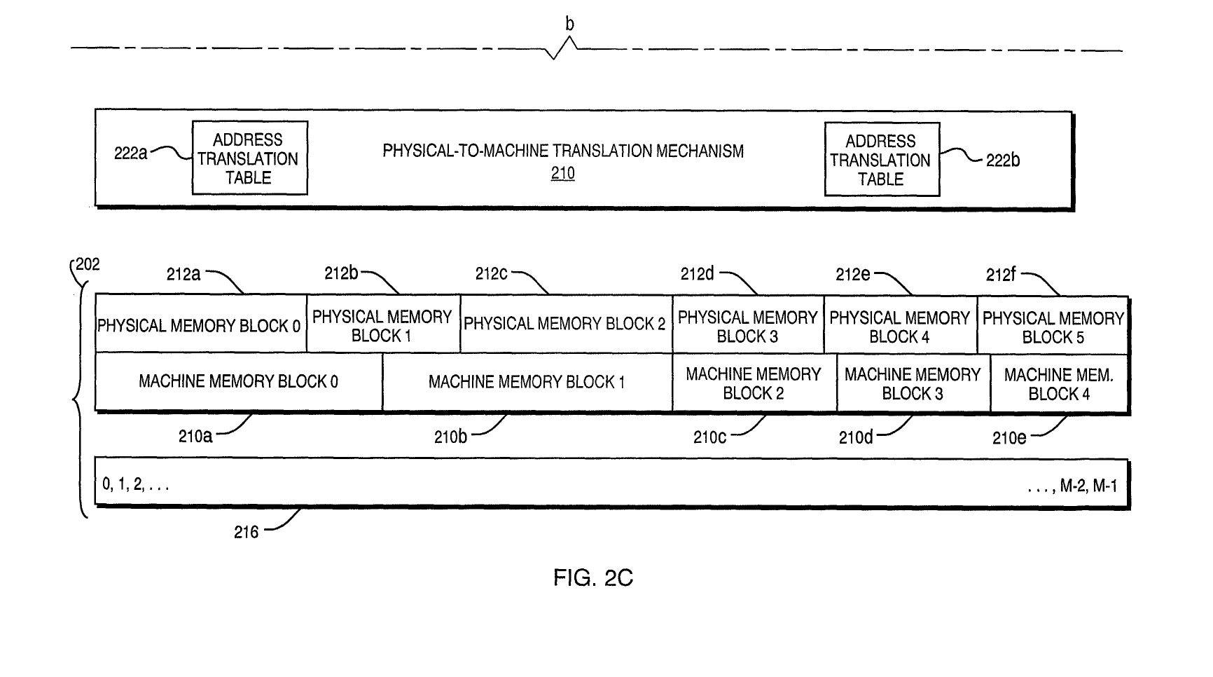

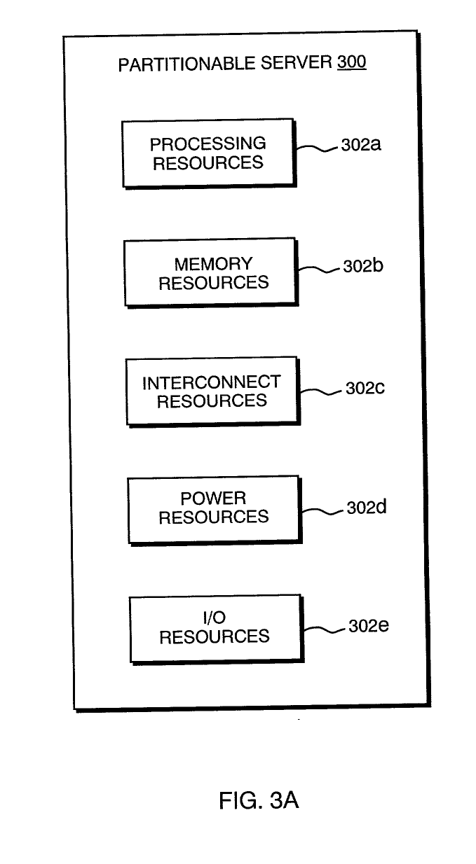

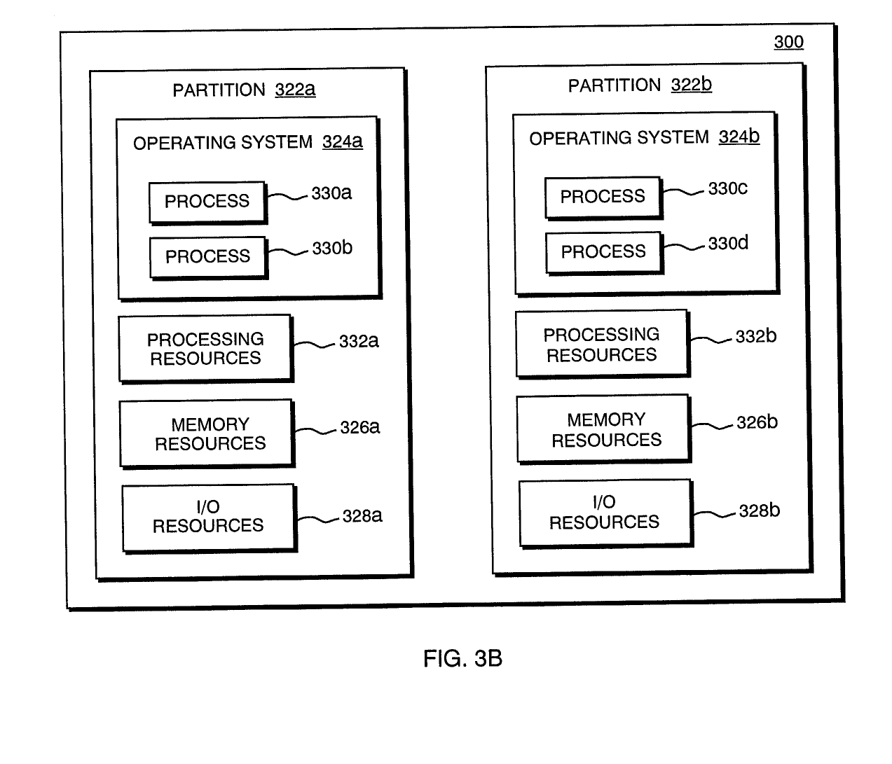

Referring to FIG. 2, a memory model 200 according to one embodiment of the present invention is shown in functional block diagram form. The model 200 may, for example, be used in conjunction with the main memory resources (e.g., RAM) of a partitionable consolidation server. For example, referring to FIG. 3A, a partitionable server 300 that is suitable for use in conjunction with the memory model 200 is shown in generalized block diagram form. The server 300 includes processing resources 302a, memory resources 302b, interconnect resources 302c, power resources 302d, and input/output (I/O) resources 302e.

Particular hardware and/or software that may be used to implement the resources 302a-e are well known to those of ordinary skill in the art and will therefore not be described in detail herein. Briefly, however, processing resources 302a may include any number and kind of processors. In some partitionable servers, however, the number of processors may be limited by features of the interconnect resources 302c. Partitionable consolidation servers, for example, typically include 8, 16, 32, or 64 processors, and the current practical limit is 128 processors for a symmetric multiprocessor (SMP). Furthermore, certain systems may require that all processors in the processing resources 302a be identical or at least share the same architecture.

Memory resources 302b may include any amount and kind of memory, such as any variety of RAM, although in practice current partitionable servers are typically limited to approximately 512 GB of RAM and may require that the same or similar kinds of RAM be used within the server 300. Partitionable consolidation servers typically include sufficient RAM to support several partitions. Server 300 will also typically have access to persistent storage resources, such as a Storage Area Network (SAN).

I/O resources 302e may include, for example, any kind and number of I/O buses, adapters, or ports, such as those utilizing SCSI or Fibre Channel technologies. Interconnect resources 302c, sometimes referred to as an interconnect fabric, interconnects resources 302a, 302b, 302d, and 302e to form an integrated computer system in any of a variety of ways as is well known to those of ordinary skill in the art. Resources 302a-e of the server 300 may be freely and dynamically allocated among two or more partitions depending on the requirements of the workload running in the respective partitions. For example, referring to FIG. 3B, a functional block diagram is shown illustrating an example in which the server 300 includes two partitions 322a-b. A first partition 322a includes processing resources 332a (which are a subset of the processing resources 302a of the server 300) and memory resources 326a (which are a subset of the memory resources 302b of the server 300). An operating system 324a executes within the partition 322a. Two processes 330a-b are shown executing within operating system 324a for purposes of example. It is well-known to those of ordinary skill in the art that a process executes “within” an operating system in the sense that the operating system provides an environment in which the process may execute, and that an operating system executes “within” a partition in the sense that the partition provides an environment in which the operating system may execute. The partition 322a also includes I/O resources 328a, which are a subset of the I/O resources 302e of the server 300.

Similarly, a second partition 322b includes processing resources 332b, memory resources 326b, I/O resources 328b, and an operating system 324b (including processes 330c-d) executing within the partition 322b. Although partitions 322a and 322b may also include and/or have access to persistent storage resources and power resources, these are not shown in FIG. 3B. It should be appreciated that resources 302a-e from the server 300 may be allocated among the partitions 322a-b in any of a variety of ways. Furthermore, it should be appreciated that although the operating system, memory resources, and I/O resources within each partition are illustrated as separate elements, these elements may depend on each other in various ways. For example, the operating system 324a may utilize the memory resources 326a to operate.

Returning to FIG. 2A, the memory model 200 includes a sub-model 214a that is used by partition 322a and a sub-model 214b that is used by partition 322b. Note that each of the sub-models 214a-b is structurally similar to the conventional memory model 100. For example, sub-model 214a includes: (1) a plurality of virtual address spaces 208a-b that correspond to the virtual address spaces 108a-c shown in FIG. 1, (2) a sequential zero-based physical address space 202a that corresponds to the physical address space 102 shown in FIG. 1, and (3) a virtual-to-physical translation mechanism 204a that corresponds to the virtual-to-physical translation mechanism 104 shown in FIG. 1. As in the conventional memory model, the virtual-to-physical translation mechanism 204a in the sub-model 214a transparently translates between virtual addresses 220a-b in the virtual address spaces 208a-b and physical addresses 216 in the physical address space 202a. In fact, the virtual-to-physical translation mechanism 204a may be a conventional virtual-to-physical translation mechanism such as the translation mechanism 104 shown in FIG. 1. As a result, a conventional operating system and other conventional software processes may execute in the partition 322a without modification. Similarly, sub-model 214b includes a virtual-to-physical translation mechanism 204b that translates between virtual addresses 220c-d in virtual address spaces 208c-d and physical addresses 218b in physical address space 202b.

One difference, however, between the physical address space 202a (FIG. 2A) and the conventional physical address space 102 (FIG. 1) is that addresses 112 in the conventional physical address space 102 map directly to hardware memory locations, while addresses 218a in the physical address space 202a map only indirectly to hardware memory locations. Instead, the memory model 200 includes an additional address space 202, referred to herein as a “machine address space,” which includes a plurality of machine addresses 216 that map directly onto memory locations in a plurality of machine (hardware) memory blocks 210a-e. The machine memory blocks 210a-e may be the same as the physical memory blocks 110a-d in the conventional memory model 100. More generally, the term “machine” (as in “machine memory” and “machine address”) is used herein to refer to the actual (hardware) memory resources 302b of the server 300. The terms “machine” and “hardware” are used interchangeably herein.

As a result, when a process (such as operating system 324a) executing in partition 322a attempts to access a memory location using a physical address in the physical address space 202a, the physical address is first translated into a machine (hardware) memory address before the memory access occurs. The memory model 200 includes a physical-to-machine translation mechanism 210 for transparently performing this translation. The translation is “transparent” in the sense that it is performed without the knowledge of the requesting process. One reason that knowledge of the requesting process is not required is that the physical address spaces 202a-b are sequential and zero-based, as is expected by processes (such as operating systems) that are designed to execute on a conventional standalone computer.

For example, if a conventional operating system executing in partition 322a issues a memory access request that is designed to access memory in the physical address space 102 (FIG. 1) of a conventional standalone computer, translation mechanism 210 may translate the specified physical address into a machine address in the machine address space 202 and instruct memory control hardware to perform the requested memory access. As a result, the translation mechanism 210 provides a transparent interface between processes executing in partitions of the server 300 and the hardware memory resources 302b of the server. The memory model 200 may therefore be used to provide each partition on a partitionable server with a sequential zero-based address space that is compatible with conventional operating systems. Conventional, unmodified operating systems may therefore use the memory model 200 to access the memory resources 302b of partitionable server 300.

The memory model 200 will now be described in more detail. Addresses 216 in the machine address space 202 may, for example, be numbered sequentially from zero to M−1, where M is the aggregate number of memory locations in the machine memory blocks 210a-e. It should be appreciated that there may be any number and kind of machine memory blocks and that, as shown in FIG. 2C, the machine memory blocks 210a-e may vary in size, although typically each has a size that is a power of two.

For purposes of example, assume hereinafter that the address boundaries of the machine memory blocks 210a-e in the machine address space 202 are as shown in Table 1. It should be appreciated that the boundaries shown in Table 1 are provided merely for purposes of example. In practice the boundaries would typically fall on powers of two, which has the beneficial effect of decreasing the overhead associated with address decoding.

TABLE 1

| Machine Memory | Lower Address | Upper Address |
|---|---|---|
| Block Number | Boundary | Boundary |
| 0 | 0 | 22,527 |
| 1 | 22,528 | 45,055 |
| 2 | 45,056 | 59,391 |
| 3 | 59,392 | 71,679 |
| 4 | 71,680 | 81,919 |

The physical-to-machine translation mechanism 210 groups the machine address space 202 into a plurality of physical memory blocks 212a-f. Although six physical memory blocks 212a-f are shown in FIGS. 2B-2C for purposes of example, there may be any number of physical memory blocks.

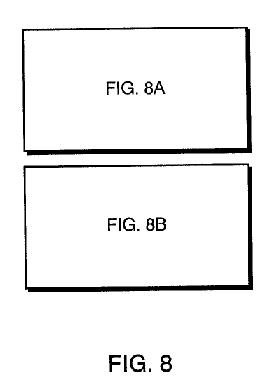

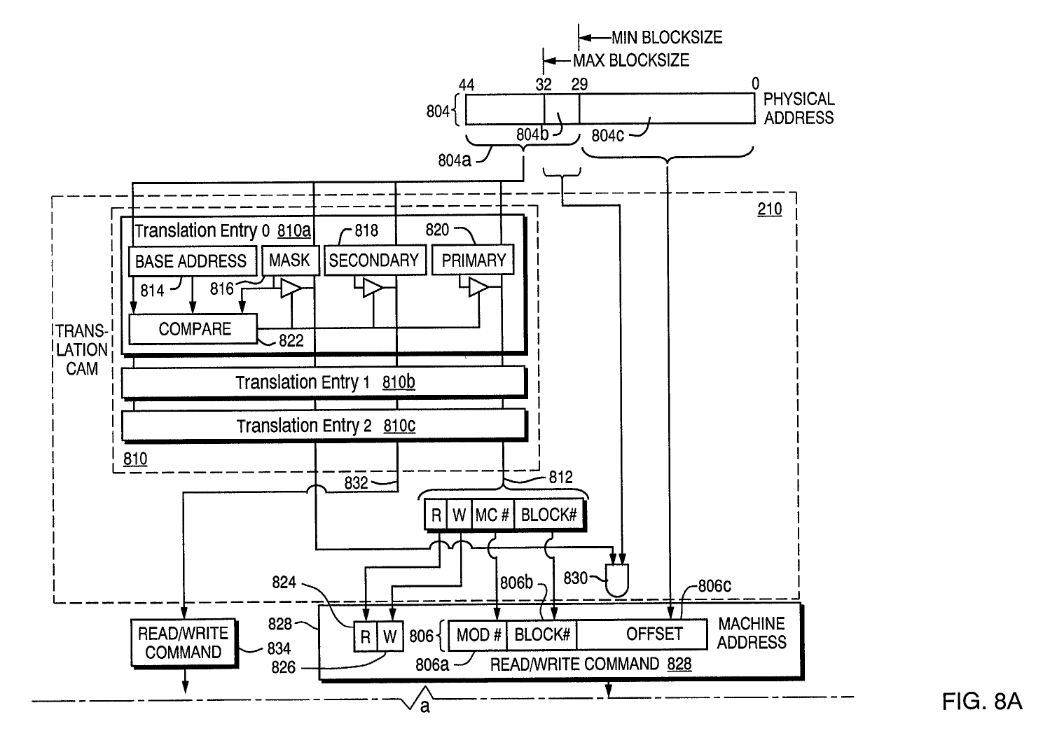

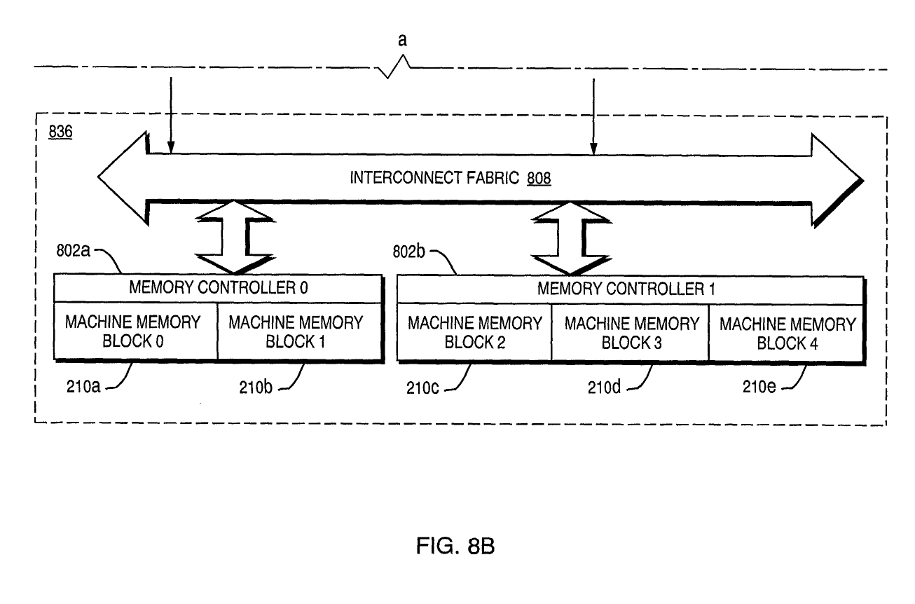

The physical memory blocks 212a-f are depicted directly above the machine memory blocks 210a-e in the machine address space 202 in FIG. 2 to indicate that there is a one-to-one mapping between memory locations in the physical memory blocks 212a-f and memory locations in the machine memory blocks 210a-e. It should be appreciated that a single physical memory block may span more than one machine memory block, less than one machine memory block, or exactly one machine memory block. Mapping of physical memory blocks 212a-f to machine memory blocks 210a-e is described in more detail below with respect to FIG. 8.

For purposes of example, assume hereinafter that the address boundaries of the physical memory blocks 212a-f in the machine address space 202 are as shown in Table 2.

TABLE 2

| Physical Memory | Lower Address | Upper Address |
|---|---|---|
| Block Number | Boundary | Boundary |
| 0 | 0 | 16,383 |
| 1 | 16,384 | 28,671 |
| 2 | 28,672 | 45,055 |
| 3 | 45,056 | 57,343 |
| 4 | 57,344 | 69,631 |
| 5 | 69,632 | 81,919 |

It should be appreciated that the translation mechanism 210 may maintain and/or use tables such as Table 1 and Table 2 to perform a variety of functions. For example, the translation mechanism 210 may use such tables to determine which physical memory block and/or machine memory block contains a memory location specified by a particular address in the machine address space 202.

The physical address spaces 202a-b will now be described in more detail. Physical address space 202a includes a contiguous array of memory locations sequentially numbered from zero to m₀−1, where m₀ is the number of memory locations in the memory resources 326a of partition 322a. The physical address space 202a is subdivided into ten contiguous pages, labeled Page 0 through Page 9. Unlike the pages shown in FIG. 1, however, which map directly to physical memory blocks 110a-d, the pages in physical address space 202a map to machine memory blocks (in particular, machine memory blocks 212a, 212e, and 212d). Similarly physical address space 202b has been allocated ten pages of memory using machine memory blocks 212c, 212f, and 212b.

Virtual address spaces 208a-d are allocated for use by processes 330a-d, respectively (FIG. 3B). The virtual address spaces 208a-d operate in the same manner as conventional virtual address spaces 108a-c (FIG. 1).

Having generally described the functions performed by the memory model 200, various embodiments of the physical-to-machine translation mechanism 210 will now be described in more detail. In one embodiment of the present invention, the physical-to-machine translation mechanism 210 maintains mappings between physical addresses 218a-b and machine addresses 216. Such a mapping may be maintained using a physical-to-machine address translation table for each of the physical address spaces 202a-b. For example, in one embodiment, physical-to-machine translation mechanism 210 maintains a physical-to-machine address translation table 222a for physical address space 202a and maintains a physical-to-machine address translation table 222b for physical address space 202b. The address translation tables 222a-b may be implemented in hardware, software, or any combination thereof.

Table 3 shows an example of the physical-to-machine address translation table 222a for physical address space 202a according to one embodiment of the present invention:

TABLE 3

| Physical address space | Machine Address Space |
|---|---|
| 0-16, 383 | 0-16, 383 |
| 16, 384-28, 671 | 57, 344-69, 631 |
| 28, 674-40, 959 | 45, 056-57, 343 |

The mappings shown in Table 3 can be explained with respect to FIG. 2 as follows. Recall that each page consists of 4 Kbytes (4096 bytes). As shown in FIG. 2, Page 0 through Page 3 in physical address space 202a have physical addresses 0-16,383. These pages map to physical memory block 212a, which in turn maps to machine addresses 0-16,383 in machine address space 202, as shown in the first row of Table 3. Page 4 through Page 6 in physical address space 202a have physical addresses 16,384-28,671 in physical address space 202a. These pages map to physical memory block 212e, which in turn maps to machine addresses 57,344-69,631 in machine address space 202, as shown in the second row of Table 3. Finally, Page 7 through Page 9 in physical address space 202a have physical addresses 28,674-40,959 in physical address space 202a. These pages map to physical memory block 212d, which in turn maps to machine addresses 45,056-57,343 in machine address space 202, as shown in the third row of Table 3.

The physical-to-machine translation mechanism 210 may use Table 3 to translate an address in the physical address space 202a into an address in the machine address space 202 using techniques that are well known to those of ordinary skill in the art. It should further be appreciated that although Table 3 maps physical addresses directly to machine addresses, the physical-to-machine address translation tables 222a-b may achieve the same result in other ways, one example of which is described below with respect to FIG. 8. More generally, the use of a translation table such as Table 3 to perform physical-to-machine address translation is provided merely for purposes of example and does not constitute a limitation of the present invention.

Furthermore, although only a single physical-to-machine address translation table (Table 3) is described above, it should be appreciated that there may be a plurality of such tables. For example, there may be one such table for each for each agent (e.g., processor or partition) that accesses memory. Each such table may provide the address translations that are needed by the corresponding agent.

Upon initialization of the partitionable server 300 (such as during boot-up), the physical-to-machine translation mechanism 210 may initialize itself. This initialization may include, for example, creating the physical memory blocks 212a-f and maintaining a record of the physical address boundaries of such blocks, as described above with respect to Table 2. The physical-to-machine translation mechanism 210 may select the number of physical memory blocks and establish their physical address boundaries in any of a variety of ways. For example, the physical-to-machine translation mechanism 210 may be pre-configured to create physical memory blocks of a predetermined size and may create as many physical memory blocks of the predetermined size as are necessary to populate the machine address space 202. Physical memory block sizes may be selected to be integral multiples of the page size (e.g., 4 Kbytes). After creating the physical memory blocks 212a-f, the physical-to-machine translation mechanism 210 uses the physical memory blocks 212a-f to allocate memory to server partitions.

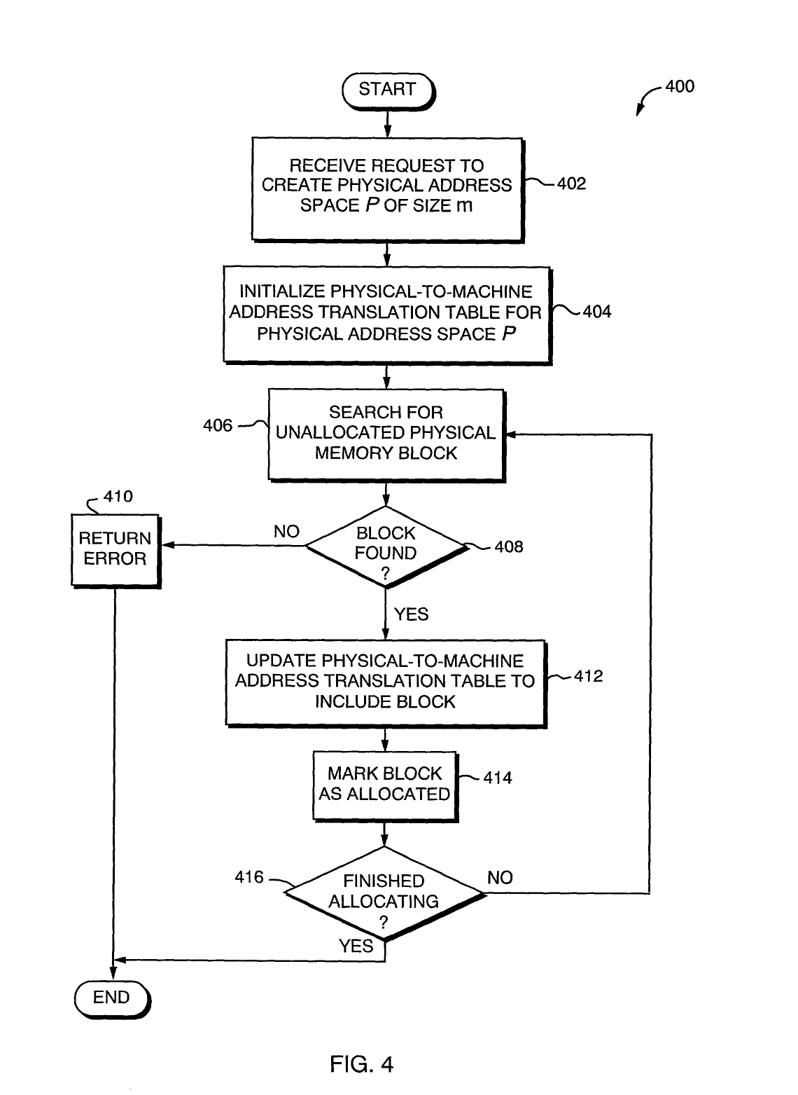

For example, referring to FIG. 4, a flow chart is shown of a method 400 that is used by the physical-to-machine translation mechanism 210 to allocate memory to a server partition (i.e., to create a physical address space) according to one embodiment of the present invention. For ease of explanation, an example will be described in which the physical address space 202a shown in FIG. 2A is created.

Referring to FIG. 4, the physical-to-machine translation mechanism 210 receives a request to create a physical address space P having m addresses (step 402). In the case of partition 322a, for example, m=m₀. The request may be received during the creation of a partition on the server 300. It should be appreciated that creation of the partition 322a includes steps in addition to the creation of a physical address space which are not described here for ease of explanation but which are well known to those of ordinary skill in the art. For example, a service processor may be responsible both for partition management (e.g., creation and deletion) and for maintenance of the physical-to-machine address translation tables 222a-b.

The physical-to-machine translation mechanism 210 creates and initializes a physical-to-machine address translation table for physical address space P (step 404). The physical-to-machine translation mechanism 210 searches for a physical memory block (among the physical memory blocks 212a-f) that is not currently allocated to any physical address space (step 406).

If no unallocated physical memory block is found (step 408), the method 400 returns an error (step 410) and terminates. Otherwise, the method 400 appends the physical memory block found in step 406 to physical address space P by updating the physical-to-machine address translation table that was initialized in step 404 (step 412) and marks the physical memory block as allocated (step 414). The physical-to-machine address translation table is updated in step 412 in a manner which ensures that physical address space P is sequentially-numbered and zero-based. More specifically, all physical memory blocks allocated to physical address space P are mapped to sequentially-numbered addresses. Furthermore, the first physical memory block allocated to physical address space P (e.g., physical memory block 212a in the case of physical address space 202a) is mapped to a sequence of addresses beginning with address zero. Finally, each subsequent physical memory block that is allocated to physical address space P is mapped to a sequence of addresses that begins at the address following the previous physical memory block in the physical address space. Performing step 412 in this manner ensures that physical address space P is a sequential zero-based address space.

If allocation is complete (step 416), the method 400 terminates. The method 400 may determine in step 416 whether allocation is complete by determining whether the total amount of memory in the physical memory blocks in the physical block list is greater than or equal to the amount of memory requested in step 402. If allocation is not complete, control returns to step 406 and additional physical memory blocks are allocated, if possible.

Assume for purposes of example that, at the time of the request received in step 402, there are no partitions on the server 300 (i.e., partitions 322a and 322b do not exist) and that, therefore, sub-memory models 214a and 214b do not exist. Assume further that the request asks for ten pages of memory to be allocated (i.e., m=10×4,096=40,960). In response to the request, the physical-to-machine translation mechanism may first (in steps 412 and 414) allocate physical memory block 212a to physical address space 202a. As shown in FIG. 2A, physical memory block 212a is large enough to provide four physical pages of memory to the physical address space 202a. In subsequent iterations of the method 400, physical memory block 212e (providing three pages) and physical memory block 212d (providing three pages) may be allocated to the physical address space 202a. As a result, the request for ten pages of memory may be satisfied by creating a sequential zero-based physical address space from the physical memory blocks 212a, 212e, and 212d.

As a result of executing the method 400 illustrated in FIG. 4 for each of the partitions 322a-b on the server 300, the translation mechanism 210 will have created physical-to-machine address translation tables 222a-b for partitions 322a-b, respectively. These address translation tables 222a-b may subsequently be used to transparently translate addresses in the physical address spaces 202a-b that are referenced in memory read/write requests by the operating systems 324a-b into addresses in the machine address space 202, and thereby to access the memory resources 302b of the server 300 appropriately and transparently.

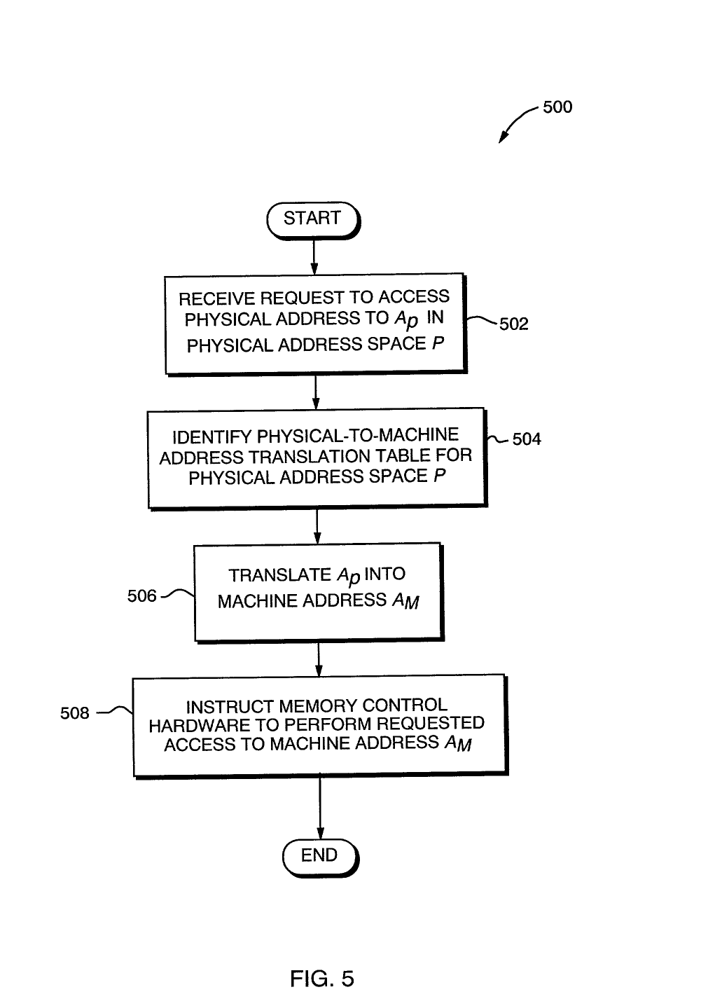

For example, referring to FIG. 5, a flowchart of a method 500 is shown that is executed by the physical-to-machine translation mechanism 210 in one embodiment of the present invention to transparently translate a physical address into a machine address. Method 500 receives a request to access a memory location having a specified physical memory address A_{P} in a physical address space P (step 502). The physical address space may, for example, be either of the physical address spaces 202a or 202b.

The request may be developed in any of a variety of ways prior to being received by the translation mechanism 210 in step 502. For example, if one of the processes 330a-d executing on the server 300 issues a request to access a virtual memory location in one of the virtual address spaces 208a-d, the appropriate one of the virtual-to-physical translation mechanisms 204a may translate the specified virtual address into a physical address in one of the physical address spaces 202a-b and issue a request to access the physical address. Alternatively, one of the operating systems 324a-b may issue a request to access a physical address in one of the physical address spaces 202a-b. In either case, the request is transparently received by the physical-to-machine translation mechanism in step 502.

In response to the request, the method 500 identifies the physical-to-machine address translation table corresponding to physical address space P (step 504). The method 500 translates the specified physical address into a machine address A_{M} in the machine address space 202 using the identified address translation table (step 506). The method 500 instructs memory control hardware to perform the requested access to machine address A_{M} (step 508), as described in more detail below with respect to FIG. 8.

It should be appreciated from the description above that the method 500 enables the physical-to-machine address translation mechanism 210 to transparently translate physical addresses to machine addresses. The method 500 may therefore be used, for example, to enable conventional operating systems to access memory in partitions of a partitionable server without modifying such operating systems.

Having described in general how the memory model 200 may be used to provide operating systems executing on a partitionable server with sequential zero-based address spaces, one embodiment of a hardware implementation of the physical-to-machine translation mechanism 210 will now be described with respect to FIG. 8.

In general, the physical-to-machine translation mechanism 210 receives a physical address 804 as an input and translates the physical address 804 into a machine address 806 as an output. For example, the physical address 804 shown in FIG. 8 may be the physical address A_{P} described above with respect to FIG. 5, and the machine address 806 shown in FIG. 8 may be the machine address A_{M} described above with respect to FIG. 5.

The translation mechanism 210 bundles the machine address 806 into a read/write command 828 that is used to instruct memory control hardware 836 to perform the requested memory access on the machine address 806.

The memory control hardware 836 may be any of a variety of memory control hardware that may be used to access machine memory in ways that are well-known to those of ordinary skill in the art. In a conventional standalone (non-partitioned) computer, memory control hardware such as hardware 836 accesses machine memory directly, without the use of translation mechanism. In various embodiments of the present invention, translation mechanism 210 is inserted prior to the memory control hardware 836 to translate physical addresses that are referenced in conventional memory access requests into machine addresses that are suitable for delivery to the memory control hardware 836.

In one embodiment, memory control hardware 836 includes a plurality of memory controllers 802a-b, each of which is used to control one or more of the machine memory blocks 210a-e. Memory controller 802a controls machine memory blocks 210a-b and memory controller 802b controls machine memory blocks 210c-e. Although only two memory controllers 802a-b are shown in FIG. 8 for purposes of example, there may be any number of memory controllers, although typically there are about as many memory controllers in the server 300 as there are processors.

Each of the memory controllers 802a-b has a distinct module number so that it may be uniquely addressable by the physical-to-machine translation mechanism 210. Similarly, each of the memory controllers 802a-b assigns a unique block number to each of the machine memory blocks that it controls. Memory locations within each of the machine memory blocks 210a-e may be numbered sequentially beginning with zero. As a result, any memory location in the machine memory blocks 210a-e may be uniquely identified by a combination of module number, block number, and offset. As shown in FIG. 8, machine address 806 includes such a combination of module number 806a, block number 806b, and offset 806c. The machine address 806 may, for example, be a word in which the low bits are used for the offset 806c, the middle bits are used for the block number 806b, and the high bits are used for the module number 806a.

It should be appreciated that machine addresses may be referenced in other ways. For example, in one embodiment, each of the memory controllers 802a-b maps the machine memory locations that it controls to a sequential zero-based machine address space, in which case each of the machine memory locations in the machine memory blocks 210a-e may be specified by a combination of module number and machine address.

Memory control hardware 836 also includes an interconnect fabric 808 that enables access to the machine memory blocks 210a-e through the memory controllers 802a-b. As described in more detail below, the translation mechanism 210 may access a machine memory location by providing to the memory control hardware 836 a read/write command containing the machine address of the memory location to access. The read/write command is transmitted by the interconnect fabric 808 to the appropriate one of the memory controllers 802a-b, which performs the requested read/write operation on the specified machine memory address.

As described above, upon initialization of the physical-to-machine translation mechanism 210, the physical-to-machine translation mechanism 210 may create a plurality of physical memory blocks 212a-f. In one embodiment, a plurality of physical memory blocks are created for each of the memory controllers 802a-b. For example, physical memory blocks 212a-c may map to the machine memory controlled by the first memory controller 802a, while physical memory blocks 212d-f may map to the machine memory controlled by the second memory controller 802b.

Although each of the physical memory blocks 212a-f (FIG. 2) does not span more than one of the memory controllers 802a-b, in practice each physical memory block is typically composed by interleaving machine memory locations from multiple memory controllers in order to increase the likelihood that all memory controllers will contribute equally to memory references generated over time.

Translation of the physical address 804 into the machine address 806 by the translation mechanism 210 in one embodiment will now be described in more detail. As described generally above with respect to Table 3, the translation mechanism 210 maintains mappings between ranges of physical addresses and ranges of machine addresses. In one embodiment, the translation mechanism 210 includes a Content Addressable Memory (CAM) 810 that maintains these mappings and translates ranges of physical addresses into ranges of machine addresses. More specifically, the CAM takes as an input a range of physical addresses and provides as an output (on output bus 812) the module number and block number of the corresponding range of machine addresses.

For example, as shown in FIG. 8, physical address 804 includes upper bits 804a and lower bits 804c. Upper bits 804a are provided to CAM 810, which outputs the module number and block number of the machine addresses that map to the range of physical addresses sharing upper bits 804a.

The CAM 810 performs this translation as follows. CAM includes a plurality of translation entries 810a-c. Although only three translation entries 810a-c are shown in FIG. 8 for purposes of example, there may be any number of translation entries (64 is typical). Furthermore, although all of the entries 810a-c have similar internal components, only the internal components of entry 810a are shown in FIG. 8 for ease of illustration.

Each of the translation entries 810a-c maps a particular range of physical addresses to a corresponding machine memory block (specified by a module number and machine block number). The manner in which this mapping is maintained is described by way of example with respect to entry 810a. The other entries 810b-c operate similarly.

The upper bits 804a of physical address 804 are provided to entry 810a. Entry 810a includes a base address register 814 that specifies the range of physical addresses that are mapped by entry 810a. Entry 810a includes a comparator 822 that compares the upper bits 804a of physical address 804 to the base address 814. If there is a match, the comparator 822 drives a primary translation register 820, which stores the module number and block number of the machine memory block that maps to the range of physical addresses specified by upper bits 804a. The module number and machine block number are output on output bus 812.

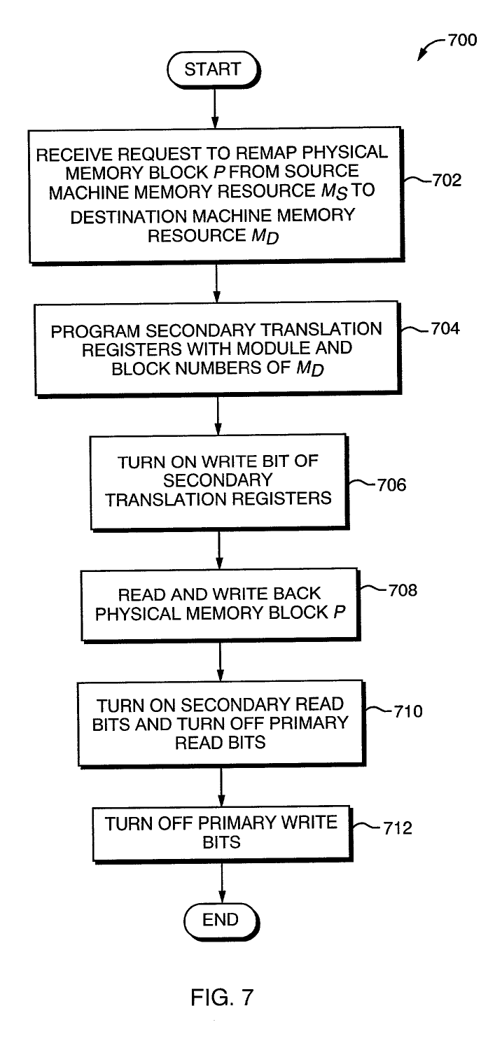

As described in more detail below with respect to FIG. 7, the translation entry 810a may also simultaneously provide a secondary mapping of the range of physical addresses specified by the base address register 814 to a secondary range of machine memory addresses. Such a secondary mapping may be provided by a secondary translation register 818, which operates in the same manner as the primary translation register 820. If a match is identified by the comparator 822, the comparator 822 drives the outputs of both the primary translation register 820 and the secondary translation register 818. The secondary translation register 818 outputs a module number and block number on secondary output bus 832, where they are incorporated into a secondary read/write command 834. The secondary read/write command 834 operates in the same manner as the primary read/write command 828 and is therefore not shown in detail in FIG. 8 or described in detail herein.

Although the example above refers only to translation entry 810a, upper bits 804a are provided to all of the translation entries 810a-c, which operate similarly. Typically only one of the translation entries 810a-c will match the upper bits 804a and output a module number and machine block number on the output bus 812. As further shown in FIG. 8, lower bits 804c of physical address 804 are used to form the offset 806c of the machine address 806.

The CAM 810 forms the read/write command 828 by combining the output module number and block number with a read (R) bit 824 and a write (W) bit 826. The R bit and 824 and W bit 826 are stored in and output by the primary translation register 820, and are both turned on by default. An asserted read bit 824 indicates that read operations are to be posted to the corresponding memory controller. Similarly, an asserted write bit 826 indicates write operations are to be posted to the corresponding memory controller.

As described above, physical block sizes may vary. As a result, the number of bits needed to specify a physical address range corresponding to a physical block may vary depending on the physical block size. For example, fewer bits will be needed to specify larger physical blocks than to specify smaller physical blocks. For example, as illustrated in FIG. 8, in one embodiment as many as 16 bits (bits 29-44 of the physical address 804) are used to specify the base address of a physical block having the minimum physical block size (indicated by “MIN BLOCKSIZE” in FIG. 8), while as few as 13 bits (bits 32-44 of the physical address 804) are used to specify the base address of a physical block having the maximum physical block size (indicated by “MAX BLOCKSIZE”). It should be appreciated that the particular maximum and minimum block sizes shown in FIG. 8 are provided merely for purposes of example.

To enable address translation when variable physical block sizes are allowed, each of the translation entries 810a-c may include a mask field. For example, as shown in FIG. 8, translation entry 810a includes mask field 816. The mask field of a translation entry is used to ensure that the number of bits compared by the translation entry corresponds to the size of the physical block that is mapped by the translation entry. More specifically, the mask field of a translation entry controls how many of middle bits 804b of physical address 804 will be used in the comparison performed by the translation entry.

The mask field 816 may be used in any of a variety of ways. If, for example, the block size of the physical block mapped by translation entry 810a has the minimum block size, then (in this example) all of the upper bits 838 should be compared by the comparator 822. If, however, the block size of the physical block mapped by translation entry 810a has the maximum block size, then (in this example), only thirteen of the sixteen upper bits 804a should be compared by the comparator 822. The value stored in mask field register 816 specifies how many of the upper bits 804a are to be used in the comparison performed by comparator 822. The value stored in mask field register 816 is provided as an input to comparator 822. The value stored in the mask field register 816 may take any of a variety of forms, and the comparator 822 may use the value in any of a variety of ways to compare the correct number of bits, as is well-known to those of ordinary skill in the art.

In embodiments in which the masking mechanism just described is employed, middle bits 804b of the physical address are routed around the translation mechanism 210 and provided to an AND gate 830, which performs a logical AND of the middle bits 804b and the mask field 816 (or, more generally, the mask field of the translation entry that matches the upper bits 804a of the physical address 804). The output of the AND gate 830 is used to form the upper part of the offset 806c. In effect, the AND gate 830 zeros unused offset bits for smaller physical block sizes. The AND gate 830 is optional and may not be used if the memory controllers 802a-b are able to ignore unused offset bits when they are not necessary.

In another aspect of the present invention, techniques are provided for remapping a physical memory block from one machine memory resource (e.g., machine memory block) to another in a partitionable server. For example, if one of the server's machine memory blocks 210a-e is replaced with a new machine memory block, the physical memory blocks that were mapped to the original machine memory block may be remapped to the new machine memory block. This remapping may be performed by the physical-to-machine translation mechanism 210. The remapping may involve copying an image from one machine memory resource (such as the physical memory block being replaced) to another machine memory resource (such as the replacement machine memory block). The same techniques may be used to perform remapping when, for example, a machine memory block is removed from or added to the server 300. In particular, techniques are provided for performing such remapping without rebooting the server 300 and without disrupting operation of the operating system(s) executing on the server.

For example, referring to FIG. 7, a flowchart is shown of a method 700 that is used by a service processor to remap a physical memory block P from one machine memory resource to another in one embodiment of the present invention. The method 700 receives a request to remap physical memory block P from a source machine memory resource M_{S} to a destination machine memory resource M_{D} (step 702). The source and destination memory resources may, for example, be machine memory blocks or portions thereof. For example, referring again to FIG. 2, if machine memory block 210a were replaced with another machine memory block, it would be necessary to remap the addresses in physical memory block 212a to addresses in the new machine memory block. In such a case, the machine memory block 210a would be the source machine memory resource M_{S} and the replacement machine memory block would be the destination memory resource M_{D}.

The method 700 then copies the contents of physical memory block P from memory resource M_{S} to memory resource M_{D}. In one embodiment, this copying is performed as follows. The method 700 programs the secondary translation registers (such as secondary translation register 818) of the translation mechanism 210 with the module and block numbers of memory resource M_{D} (step 704). Physical memory block P is now mapped both to memory resource M_{S} (primary mapping) and to memory resource M_{D} (secondary mapping).

The method 700 turns on the write (W) bits of the secondary translation registers (step 706). Since the write bits of the primary translation registers are already turned on, turning on the write bit of the secondary translation registers causes all write transactions to be duplicated to both memory resources M_{S} and M_{D}.

The method 700 then reads and writes back all of physical memory block P (step 708). Because block P is mapped both to memory resource M_{S} and to memory resource M_{D}, performing step 708 causes the contents of physical memory block P to be copied from memory resource M_{S} to memory resource M_{D}. In one embodiment, one of the server's processors performs step 708 by reading and then writing back each memory location in physical memory block P. The technique of step 708 may not work, however, with some processors which do not write back unchanged values to memory. One solution to this problem is to provide the server 300 with at least one processor that recognizes a special instruction that forces clean cast outs of the memory cache to cause a writeback to memory. Another solution is to add a special unit to the interconnect fabric 808 that scans physical block P, reading and then writing back each of its memory locations.

The method 700 turns on the read (R) bits of the secondary translation registers (such as secondary translation register 818) and turns off the read bits in the primary translation registers (such as primary translation register 820) (step 710). The read and write bits of the secondary translation registers are now turned on, while only the write bits of the primary translation registers are turned on. Since each processor may have its own translation CAM, and it is typically not possible to modify all the translation CAMs simultaneously, it may be necessary to perform the switching of the primary and secondary read bits one at a time.

The method 700 then turns off the write bits of the primary translation registers (step 712). The physical memory block P has now been remapped from memory resource M_{S} to memory resource M_{D}, without requiring the server 300 to be rebooted and without otherwise interrupting operation of the server 300. The secondary translation registers map physical block P to memory resource M_{D}, which contains an exact replica of the contents of physical block P. Furthermore, both the read and write bits of the primary translation registers are now turned off, and both the read and write bits of the secondary translation registers are now turned on. As a results, subsequent accesses to addresses in physical block P will map to corresponding addresses in memory resource M_{D}. Memory resource M_{S} may be removed for servicing or used for other purposes.

Although the method 700 described above with respect to FIG. 7 only remaps a single physical memory block, those of ordinary skill in the art will appreciate how to remap multiple physical memory blocks and portions of physical memory blocks using similar techniques. If, for example, machine memory blocks 210a and 210b (FIG. 2) were replaced with one or more new machine memory blocks, physical memory blocks 212a, 212b, and 212c would be remapped to the new machine memory blocks. Alternatively, if only machine memory block 210a were replaced with a new physical memory block, all of physical memory block 212a and only a portion of physical memory block 212b would be remapped to the new machine memory block.

Although the particular embodiments described above describe the use of the physical-to-machine translation mechanism 210 to provide a layer of indirection between the memory resources 302b of the server 300 (FIG. 3A) and processes executing in partitions 322a-b of the server 300 (FIG. 3B), it should be appreciated that various embodiments of the present invention may be employed to provide a layer of indirection between processes and other resources of the server 300, such as the I/O resources 302e. This layer of indirection may advantageously allow conventional unmodified operating systems executing in partitions 322a-b of the server 300 to access the server's I/O resources 302e.

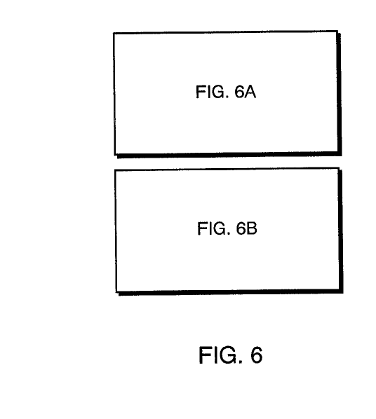

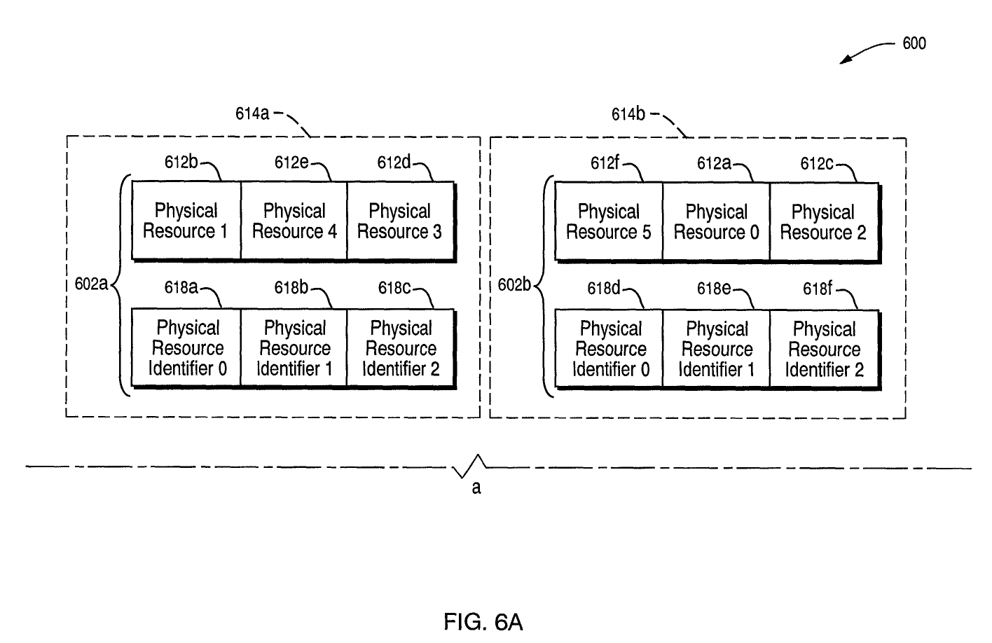

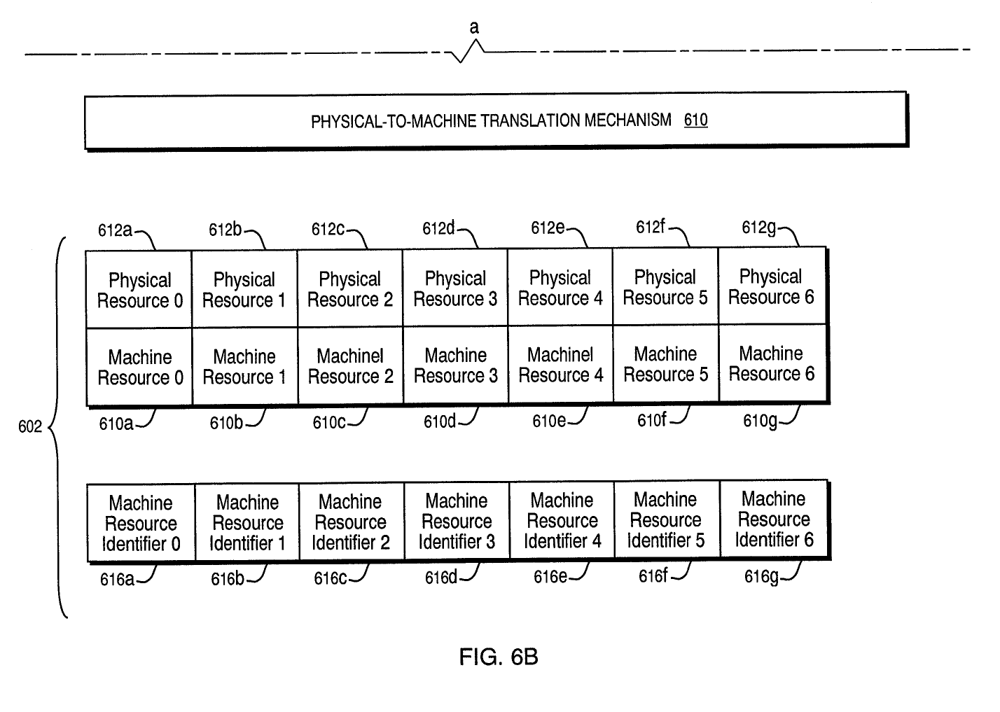

Referring to FIG. 6, a generalized physical resource model 600 according to one embodiment of the present invention is shown in functional block diagram form. Just as the model 200 shown in FIG. 2 may be used to provide a physical memory address space that may be accessed by processes executing in partitions of the server 300, the model 600 shown in FIG. 6 may be used more generally to provide a physical address space for accessing resources of any of a variety of types, such as processing resources 302a, memory resources 302b, interconnect resources 302c, power resources 302d, or I/O resources 302e. In general, an address space for a collection of resources is also referred to herein as a “resource identifier space.”

The model 600 includes a plurality of resources 610a-g, which may be a plurality of resources of a particular type (e.g., I/O resources or processing resources). The model 600 includes a machine address space 602 that maps the machine resources 610a-g to a plurality of machine resource identifiers 616a-g. For example, in the case of memory resources, the machine resource identifiers 616a-g may be the addresses 216 (FIG. 2C). In the case of I/O resources, the machine resource identifiers may be port numbers or any other predetermined identifiers that the server 300 uses to identify hardware (machine) I/O resources. An operating system executing in a conventional non-partitioned computer typically accesses machine resources 610a-g directly using machine resource identifiers 616a-g. Although the machine address space 602 shown in FIG. 6 is sequential and zero-based, this is merely an example and does not constitute a limitation of the present invention.

Model 600 includes a physical-to-machine translation mechanism 610, which maps machine resources 610a-g to physical resources 612a-g. One example of such a mapping is the mapping between memory locations in machine memory blocks 210a-e and memory locations in physical memory block 212a-f (FIG. 2).

Model 600 includes sub-models 614a and 614b, which correspond to partitions 322a and 322b of the server 300 (FIG. 3B), respectively. Upon creation of a partition, the physical-to-machine translation mechanism allocates one or more of the unallocated physical resources 612a-g to the partition. The physical-to-machine translation mechanism 610 maps the allocated physical resources to a physical address space for the partition. For example, model 214a includes physical address space 602a, which includes a plurality of physical addresses 618a-c, corresponding to physical resources 612b, 612e, and 612d, respectively. Similarly, model 214b includes physical address space 602b, which includes a plurality of physical addresses 618d-f, corresponding to physical resources 612f, 612a, and 612c, respectively. A particular example of such a physical address space in the case of memory resources is described above with respect to FIG. 4.

The physical-to-machine translation mechanism 610 is logically interposed between the machine resources 610a-g of the server 300 and the operating systems 324a-b executing in the partitions 322a-b. The physical-to-machine translation mechanism 610 translates between physical resource identifiers 618a-f referenced by the operating systems 324a-b and machine resource identifiers 616a-g that refer directly to the server's machine resources 610a-g. As a result, when the operating systems 324a-b attempt to access one of the machine resources 610a-g using one of the physical resource identifiers 618a-f, the physical-to-machine translation mechanism 610 translates the specified physical resource identifier into the corresponding machine resource identifier and transparently performs the requested access on behalf of the operating system. The physical-to-machine translation mechanism 610 therefore provides the appearance to each of the operating systems 324a-b that it is executing on a single non-partitioned computer.

For example, in one embodiment, I/O resources 302e are accessed using “memory-mapped I/O.” The term “memory-mapped I/O” refers to the use of the same instructions and bus to communicate with both main memory (e.g., memory resources 302b) and I/O devices (e.g., I/O resources 302e). This is in contrast to processors that have a separate I/O bus and use special instructions to access it. According to memory-mapped I/O, the I/O devices are addressed at certain reserved address ranges on the main memory bus. These addresses therefore cannot be used for main memory. Accessing I/O devices in this manner usually consists of reading and writing certain built-in registers. The physical-to-machine translation mechanism 210 (FIG. 2) may be used to ensure that requests by the operating systems 324a-b to access any of these built-in registers are mapped to the appropriate memory locations in the server's memory resources 302b, thereby transparently enabling memory-mapped I/O within partitions of a partitionable server.

In one embodiment, the techniques described above are used to virtualize the interrupt registers of CPUs in the server's processing resources 302a. By way of background, a CPU typically includes several special memory locations referred to as interrupt registers, each of which has a particular address that may be used to write to the register. A side effect of writing a particular CPU interrupt register with a particular pattern may be to cause an interrupt to the CPU. The particular interrupts that are supported varies among CPUs, as is well-known to those of ordinary skill in the art.

It is desirable in some circumstances to move the context running on one of the server's processors (in the processing resources 302a) to another processor. In the normal course of operation, however, I/O adapters and other software often become aware of the addresses of the CPU interrupt registers, and it can be difficult to reprogram such adapters and other software to use different interrupt register addresses. It is therefore desirable that the interrupt register addresses that are used by I/O adapters and other software remain unchanged even when an image is migrated from one processor to another.

The memory remapping techniques described above with respect to FIG. 7 may be used to achieve this goal in one embodiment of the present invention. Consider an example in which it is desired to move the image executing on a first processor to a second processor within the server's processing resources 302a. When the system administrator decides to perform this migration, he will typically inform the service processor of his intentions to perform the migration. The service processor locates an idle CPU (among the processing resources 302a) that is not allocated to any partition, and will interrupt the first processor (the processor to be vacated). This interrupt may be a special interrupt of which the operating system executing on the first processor is not aware. This special interrupt vectors the thread of execution to low-level code executing below the operating system that is used for initialization and to hide implementation-specific details from the operating system. Such code is common in modern computer systems and may, for example, be implemented using embedded CPU microcode and/or instruction sequences fetched from a specific system-defined location. The low-level code causes the context to be transported from the first processor to the second processor, and execution resumes on the second processor.

As described above, however, it is desirable that CPU interrupt register addresses be unchanged as a result of a context switch from one processor to another. The memory remapping techniques describes above with respect to FIG. 7 may be used to achieve this. Once the service processor has identified the second CPU, accesses to the first CPU's interrupt registers may temporarily be duplicated to the second CPU's interrupt registers in a manner similar to that in which main memory writes are temporarily duplicated to two memory blocks as described above with respect to FIG. 7 and shown in FIG. 8. The first CPU's interrupt registers play the role of the source memory resource Ms (primary mapping) described above, while the second CPU's interrupt registers play the role of the destination memory resource M_{D} (secondary mapping).

As a result, interrupts will be sent to both the first and second CPUs. While the context movement process is being performed, the first CPU continues to process the interrupts, while the second CPU collects interrupts but does not act on them. When context movement is complete, the first CPU stops processing interrupts, and the second CPU begins processing and servicing interrupts. As a result of using the techniques just described, I/O adapters and other software may continue to access CPU interrupt registers using the same addresses as before the context switch. The translation mechanism 210 transparently translates these addresses into the addresses of the interrupt registers in the second CPU.

Although it is possible that one or more interrupts may be serviced multiple times using this scheme, such duplicate servicing is typically not problematic because interrupt servicing routines typically poll the interrupting device to determine whether it needs service.

Among the advantages of the invention are one or more of the following.

It is desirable that each partition in a partitionable server be functionally equivalent to a standalone (non-partitioned) computer. For example, it is desirable that the interface between an operating system and the partition in which it executes be functionally equivalent to the interface between an operating system and the hardware of a standalone computer. The partition should, for example, present to the operating system a sequential zero-based address space. Because conventional operating systems are designed to work in conjunction with such an address space, a partition that transparently presents such an address space would be capable of supporting a conventional operating system without modification.

One advantage of various embodiments of the present invention is that they provide sequential zero-based address spaces within partitions of a partitionable server. Conventional operating systems are typically designed to assume that the physical address space that they address is numbered sequentially beginning with zero. This assumption is true for non-partitioned computers, but not for partitioned computers. A conventional operating system, therefore, may fail to execute within a partition that does not have a sequential zero-based address space. Various embodiments of the present invention that provide sequential zero-based address spaces may therefore be advantageously used to allow unmodified conventional operating systems to execute within partitions of a partitionable server. Such operating systems include, for example, operating systems in the Microsoft Windows® line of operating systems (such as Windows NT, Windows 2000, and Windows XP), as well as Unix operating systems and Unix variants (such as Linux). This is advantageous for a variety of reasons, such as the elimination of the need to customize the operating system to execute within a partition of a partitionable server and the near-elimination of the performance penalties typically exhibited by other partitioning schemes, as described above.

Similarly, the transparent provision of a sequential zero-based address space may be used to enable partitions to work with any hardware configuration that is supported by an operating system executing within the partition. Furthermore, existing application programs that execute within the operating system may execute within the partition without modification.

Because the necessary address translation is provided by the physical-to-machine translation mechanism 210 and not by the operating system, no additional level of indirection is required in the operating system page tables. This may eliminate or greatly reduce the performance penalties that typically result from providing the additional level of indirection within the operating system page tables.

Because address translation is performed at the hardware level, various embodiments of the present invention advantageously provide a level of hardware-enforced inter-partition security that may be more secure than software-enforced security schemes. Such security may be used instead of or in addition to software-enforced security mechanisms.

Another advantage of various embodiments of the present invention is the translations performed by the translation mechanism 210 may impose only a small performance penalty. In particular, translations may be performed quickly and in parallel with other processing by implementing the translation mechanism 210 in hardware, as shown, for example, in FIG. 8. Such a hardware implementation may perform translation quickly and without requiring modification to operating system page tables.

It is to be understood that although the invention has been described above in terms of particular embodiments, the foregoing embodiments are provided as illustrative only, and do not limit or define the scope of the invention. Various other embodiments, including but not limited to the following, are also within the scope of the claims.

Elements and components described herein may be further divided into additional components or joined together to form fewer components for performing the same functions. The techniques described above may be implemented, for example, in hardware, software, firmware, or any combination thereof. The techniques described above may be implemented in one or more computer programs executing on a programmable computer including a processor, a storage medium readable by the processor (including, for example, volatile and non-volatile memory and/or storage elements), at least one input device, and at least one output device. Program code may be applied to input entered using the input device to perform the functions described and to generate output. The output may be provided to one or more output devices.

Each computer program within the scope of the claims below may be implemented in any programming language, such as assembly language, machine language, a high-level procedural programming language, or an object-oriented programming language. The programming language may, for example, be a compiled or interpreted programming language. The term “process” as used herein refers to any software program executing on a computer.

Each such computer program may be implemented in a computer program product tangibly embodied in a machine-readable storage device for execution by a computer processor. Method steps of the invention may be performed by a computer processor executing a program tangibly embodied on a computer-readable medium to perform functions of the invention by operating on input and generating output. Suitable processors include, by way of example, both general and special purpose microprocessors. Generally, the processor receives instructions and data from a read-only memory and/or a random access memory. Storage devices suitable for tangibly embodying computer program instructions include, for example, all forms of non-volatile memory, such as semiconductor memory devices, including EPROM, EEPROM, and flash memory devices; magnetic disks such as internal hard disks and removable disks; magneto-optical disks; and CD-ROMs. Any of the foregoing may be supplemented by, or incorporated in, specially-designed ASICs (application-specific integrated circuits). A computer can generally also receive programs and data from a storage medium such as an internal disk (not shown) or a removable disk. These elements will also be found in a conventional desktop or workstation computer as well as other computers suitable for executing computer programs implementing the methods described herein, which may be used in conjunction with any digital print engine or marking engine, display monitor, or other raster output device capable of producing color or gray scale pixels on paper, film, display screen, or other output medium.

What is claimed is:

1. In a partitionable computer system including a plurality of machine resources having a plurality of machine resource identifiers, a method for creating a physical resource identifier space in a partition of the partitionable computer system, the method comprising steps of:
(A) establishing a mapping between a plurality of physical resource identifiers and at least some of the plurality of machine resource identifiers, wherein the plurality of physical resource identifiers are numbered sequentially beginning with zero; and
(B) providing, to a software program executing in the partition, an interface for accessing the at least some of the plurality of machine resources using the plurality of physical resource identifiers.

2. The method of claim 1, wherein the plurality of machine resources comprises a plurality of machine memory locations, wherein the plurality of machine resource identifiers comprises a plurality of machine memory addresses, wherein the machine resource identifier space comprises a machine memory address space, and wherein the plurality of physical resource identifiers comprises a plurality of physical memory addresses.

3. The method of claim 1, further comprising a step of performing the steps (A) and (B) for each of a plurality of partitions of the partitionable computer.

4. The method of claim 1, wherein the step (A) comprises a step of creating an address translation table that records the mapping between the plurality of physical resource identifiers and the at least some of the plurality of machine resource identifiers.

5. The method of claim 1, wherein the interface comprises means for translating a physical resource identifier selected from among the plurality of physical resource identifiers into one of the plurality of machine resource identifiers in accordance with the mapping.

6. The method of claim 1, wherein the interface comprises a Content Addressable Memory that establishes the mapping.

7. The method of claim 1, wherein the software program comprises an operating system.

8. In a partitionable computer system including a plurality of machine resources having a plurality of machine resource identifiers, an apparatus comprising:
mapping means for establishing a mapping between a plurality of physical resource identifiers and at least some of the plurality of machine resource identifiers, wherein the plurality of physical resource identifiers are numbered sequentially beginning with zero; and
interface means for accessing the at least some of the plurality of machine resources in response to requests from a software program executing in a partition of the partitionable computer system, wherein the requests identify the at least some of the plurality of machine resources using the plurality of physical resource identifiers.

9. The apparatus of claim 8, wherein the plurality of machine resources comprises a plurality of machine memory locations, wherein the plurality of machine resource identifiers comprises a plurality of machine memory addresses, wherein the machine resource identifier space comprises a machine memory address space, and wherein the plurality of physical resource identifiers comprises a plurality of physical memory addresses.

10. The apparatus of claim 8, wherein the mapping means comprises means for creating an address translation table that records the mapping between the plurality of physical resource identifiers and the at least some of the plurality of machine resource identifiers.

11. The apparatus of claim 8, wherein the interface means comprises means for translating a physical resource identifier selected from among the plurality of physical resource identifiers into one of the plurality of machine resource identifiers in accordance with the mapping.

12. The apparatus of claim 8, wherein the interface means comprises a Content Addressable Memory that establishes the mapping.

13. The apparatus of claim 8, wherein the software program comprises an operating system.

14. In a partitionable computer system including a plurality of machine resources having a plurality of machine resource identifiers, a method for accessing a select one of the plurality of machine resources specified by a physical resource identifier, the method comprising steps of:
(A) identifying a mapping associated with a partition in the partitionable computer system, wherein the mapping maps a plurality of physical resource identifiers in a sequential zero-based physical resource identifier space of the partition in to at least some of the plurality of machine resource identifiers;
(B) translating the physical resource identifier into a machine resource identifier using the mapping, wherein the machine resource identifier specifies the select one of the plurality of machine resources; and
(C) causing the select one of the plurality of machine resources to be accessed using the machine resource identifier.

15. The method of claim 14, wherein the plurality of machine resources comprises a plurality of machine memory locations, wherein the plurality of machine resource identifiers comprises a plurality of machine memory addresses, wherein the machine resource identifier space comprises a machine memory address space, and wherein the plurality of physical resource identifiers comprises a plurality of physical memory addresses.

16. The method of claim 14, wherein the step (C) comprises a step of reading a datum from the machine memory address.

17. The method of claim 14, wherein the step (C) comprises a step of writing a datum to the machine memory address.

18. In a partitionable computer system including a plurality of machine resources having a plurality of machine resource identifiers, an apparatus for accessing a select one of the plurality of machine resources specified by a physical resource identifier, the apparatus comprising:
means for identifying a mapping associated with a partition in the partitionable server, wherein the mapping maps a plurality of physical resource identifiers in a sequential zero-based physical resource identifier space of the partition to at least some of the plurality of machine resource identifiers;
means for translating the physical resource identifier into a machine resource identifier using the mapping, wherein the machine resource identifier specifies the select one of the plurality of machine resources; and
means for causing the select one of the plurality of machine resources to be accessed using the machine resource identifier.

19. The apparatus of claim 18, wherein the plurality of machine resources comprises a plurality of machine memory locations, wherein the plurality of machine resource identifiers comprises a plurality of machine memory addresses, wherein the machine resource identifier space comprises a machine memory address space, and wherein the plurality of physical resource identifiers comprises a plurality of physical memory addresses.

20. The apparatus of claim 18, wherein the means for accessing comprises means for reading a datum from the machine memory address.

21. The apparatus of claim 18, wherein the means for accessing comprises a means for writing a datum to the machine memory address.

22. The apparatus of claim 18, wherein the means for translating comprises a Content Addressable Memory.

23. In a partitionable computer system including a plurality of machine memory locations having a plurality of machine memory addresses, the partitionable computer system further including a plurality of physical memory locations having a plurality of physical memory addresses that are mapped to at least some of the plurality of machine memory addresses, the partitionable computer system further including a plurality of partitions executing a plurality of software programs, a method comprising steps of:
(A) selecting a first subset of the plurality of physical memory locations, the first subset of the plurality of memory locations being mapped to a first subset of the plurality of machine memory addresses; and
(B) remapping the first subset of the plurality of memory locations to a second subset of the plurality of machine memory addresses without rebooting the partitionable computer system.

24. The method of claim 23, further comprising a step of:
(C) prior to the step (B), copying the contents of the first subset of the plurality of machine memory addresses to the second subset of the plurality of machine memory addresses.

25. In a partitionable computer system including a plurality of machine memory locations having a plurality of machine memory addresses, the partitionable computer system further including a plurality of physical memory locations having a plurality of physical memory addresses that are mapped to at least some of the plurality of machine memory addresses, the partitionable computer system further including a plurality of partitions executing a plurality of software programs, an apparatus comprising:
means for selecting a first subset of the plurality of physical memory locations, the first subset of the plurality of memory locations being mapped to a first subset of the plurality of machine memory addresses; and
means for remapping the first subset of the plurality of memory locations to a second subset of the plurality of machine memory addresses without rebooting the partitionable computer system.

26. The apparatus of claim 25, further comprising:
means for copying the contents of the first subset of the plurality of machine memory addresses to the second subset of the plurality of machine memory addresses.
